(19) United States
(12) Patent Application Publication
(10) Pub. No.: US 2010/0117634 A1
(43) Pub. Date: May 13, 2010

(54) Wide Field ID-OD Discriminator

(76) Inventor: Philip M Hoyt, Murray, UT (US)

Correspondence Address: Warren M Pate;WARREN M. PATE, LLC, P.O. Box 9758, Salt Lake City, UT, 84109, US

(21) Appl. No.: 12/269,875

(22) Filed: Nov. 12, 2008

(51) Int. Cl. G01N 27/82

(52) U.S. Cl. 324/220

(57) ABSTRACT

A Wide Field ID-OD Discriminator for inspection of ferromagnetic pipe from the interior of the pipe. The embodiment concentrates the flux field from the full field of coverage to the sensors.

### BACKGROUND

Some pipeline inspection tools identify defects that occur in ferromagnetic pipe both on the inside diameter (ID) and on the outside diameter (OD) of the pipe but do not distinguish between those positions. Most such tools also use a secondary defect detection system that recognizes defects on the inside diameter only but that does not have penetration strong enough to recognize defects that exist on the outside diameter. An inference is made that if the primary device identifies a defect but the secondary device does not, the defect is located on the pipe OD. If both the primary and secondary devices recognize a defect, it is located on the pipe ID.

Technologies in use for such secondary detection systems include eddy current sensors that examine only material near the sensor; residual field magnetic sensors that examine the flux field outside the primary field where the field is much weaker and will not be affected unless the defect is near the sensor on the pipe ID; and small induced magnetic fields that are affected by ID defects but that are too weak to penetrate to the pipe OD. These technologies require numerous sensors in the secondary system, usually about half as many sensors as exist in the primary sensing system.

### BRIEF DESCRIPTION OF THE DRAWINGS

FIG. 1 is a side view of a system of the embodiment.

FIG. 2 is a top view of a flux concentrator.

FIG. 3 is a top view of the flux field in one of the flux concentrators of the embodiment.

FIG. 4 is a side view of the embodiment.

FIG. 5 is a top view of the embodiment.

### DETAILED DESCRIPTION OF THE EMBODIMENT

Elements of the embodiment are:
1 odometer wheel
2 polyurethane cup
3 canister
4 coupler
5 primary sensor section
6 wide field ID-OD discriminators
7 flux concentrator
8 magnets
9 sensor
10 backbar

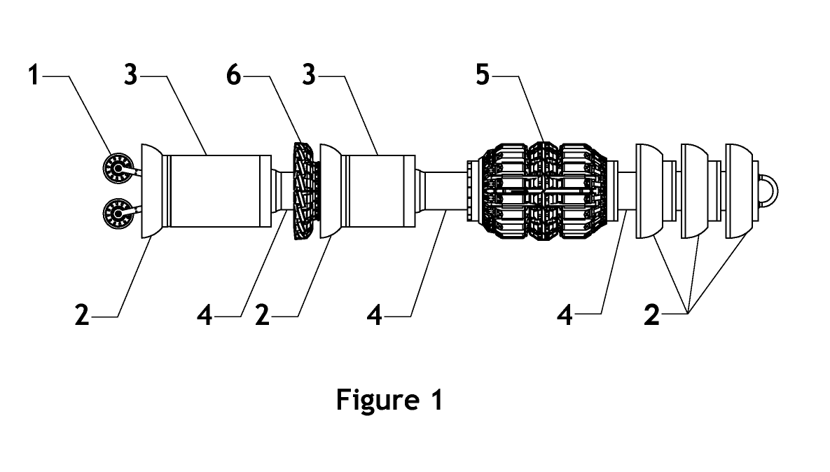

FIG. 1 shows a pipeline inspection vehicle. The embodiment comprises canisters 3 containing electronic circuitry. The canisters 3 are attached to the vehicle by flexible couplers 4. The embodiment comprises the primary field sensor section 5 and wide field ID-OD discriminators 6 to identify pipeline anomalies, odometer wheels 1 to locate anomalies in the pipeline wall, and polyurethane cups 2 to support and propel the vehicle in the pipeline.

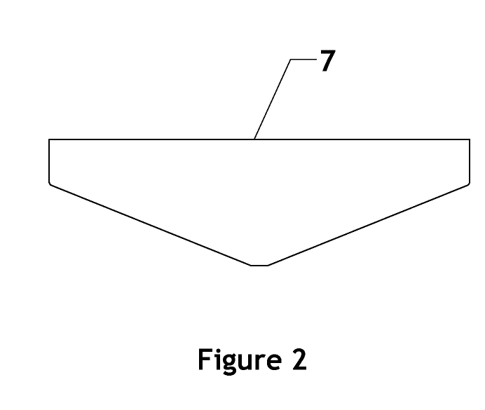

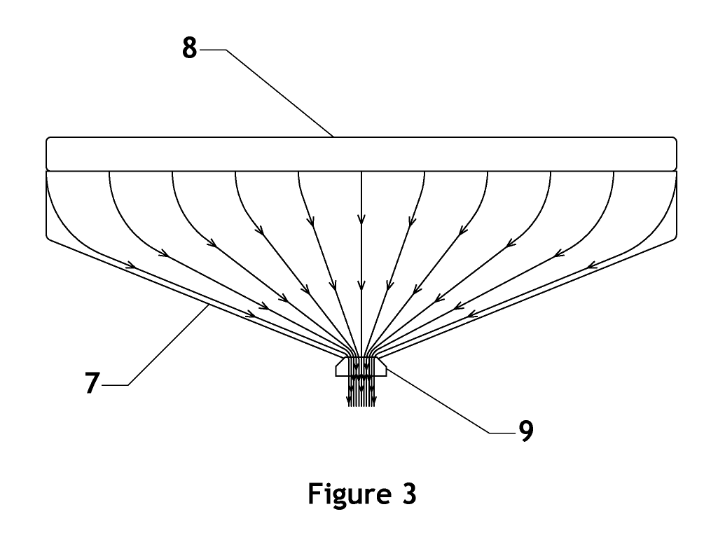

FIG. 2 shows a typical flux concentrator 7 from a wide field ID-OD discriminator 6. It has a wide end where flux enters and is concentrated to the narrow end as shown in FIG. 3. The embodiment comprises two such concentrators.

FIG. 3 shows the flux field in the flux concentrator 7, one of the magnets 8 that create the flux field, and the concentrated flux field at the sensor 9.

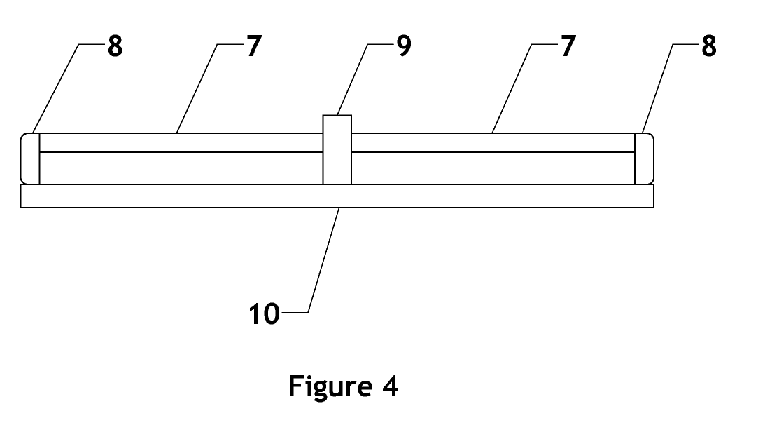

FIG. 4 shows a side view of the of the embodiment with sensor 9, the flux concentrators 7, the magnets 8 and the back bar 10 as they are assembled to concentrate the flux field.

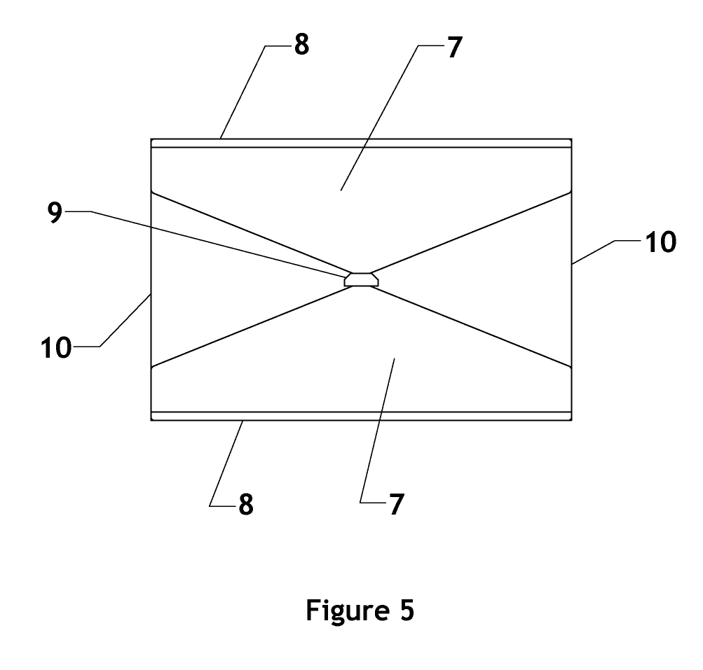

FIG. 5 shows a top view of the embodiment with sensor 9, the flux concentrator 7, the magnets 8 and the back bar 10 as they are assembled to concentrate the flux field from the full field of coverage to the sensors. The sensor 9 may be replaced by a plurality of sensors.

The embodiment comprises a secondary inspection system that recognizes ID defects but that does not recognize OD defects. The magnetic field of magnets 9 is partially induced into the pipe wall and partially passes through the flux concentrators 8. The concentrators cover the entire width of the field being monitored. They also raise the amplitude of the flux field at the sensor to produce a higher signal to noise ratio. The field induced into the pipe wall is weak and does not penetrate to the outside of the pipe. It is altered by ID defects that exist on the pipe interior but not by OD defects. When an ID defect affects the field in the pipe wall anywhere across the wide width of the flux concentrators 8, it also affects the concentrated field in the flux concentrators and the change is sensed by the sensor 10. Any change in the field anywhere across the width of the embodiment is sensed by the single sensor 10 and a defect located within that width is recognized as being located on the ID. When a plurality of sensors is used, they are connected in a single circuit. Any change in the magnetic field caused by a defect anywhere across the width of the embodiment is recognized by a single data line and a single recording channel.

What is claimed is:

1. A Wide Field ID-OD Discriminator for inspection of ferromagnetic pipe from the interior of the pipe, comprising:
a pair of low level magnets;
a flux concentrator;
and at least one sensor.

2. The Wide Field ID-OD Discriminator of claim one, wherein said Wide Field ID-OD Discriminator is an element of an instrumented in-line inspection vehicle.

3. The Wide Field ID-OD Discriminator of claim two, wherein said Wide Field ID-OD Discriminator is used to detect defects on the inside of pipelines.
